(19) United States
(12) Patent Application Publication
(10) Pub. No.: US 2005/0164793 A1
(43) Pub. Date: Jul. 28, 2005

(54) Methods and apparatus to facilitate network-based multiplayer games

(75) Inventors: Barak Merimovich, Petach-Tikva (IL); Shal Haim, Tel-Aviv (IL); Arie Faingold, Petah Tikva (IL)

Correspondence Address: Schwegman, Lundberg, Woessner & Kluth, P.A., P.O. Box 2938, Minneapolis, MN, 55402, US

(73) Assignee: BettingCorp UK Ltd.

(21) Appl. No.: 11/044,940

(22) Filed: Jan. 27, 2005

Related U.S. Application Data
(60) Provisional application No. 60/539,618, filed on Jan. 27, 2004.

(51) Int. Cl. G06F 19/00; G06F 17/00

(52) U.S. Cl. 463/42

(57) ABSTRACT

In an embodiment, a server enables one or more users to join a network-based, multiplayer game from one or more client devices. During game play, the server may receive one or more requests from the client devices, and hold the one or more requests in a virtual waiting area. The server may release the one or more requests upon an occurrence of a release condition.

### RELATED APPLICATION INFORMATION

The present application claims the benefit of the filing date of U.S. provisional application Ser. No. 60/539,618, filed Jan. 27, 2004, the contents of which is incorporated herein by reference.

### BACKGROUND

With the advent of network-based communications, multiplayer games have been developed, in which multiple people at different computers may participate in the same game over a network. For example, in a network-based blackjack game, multiple players at client computers may join a server-controlled blackjack table. In such a game, each player may perform an action that may affect the state of the table. The server, also, may perform actions that affect the state of the table. Notifying each of the multiple players when the table state is changed presents technical challenges in network-based, multiplayer game systems.

### SUMMARY

In various embodiments, the inventive subject matter relates to methods and apparatus for processing information.

### BRIEF DESCRIPTION OF THE DRAWINGS

The appended claims point out different embodiments of the inventive subject matter with particularity. However, the detailed description presents a more complete understanding of the inventive subject matter when considered in connection with the figures, wherein like-reference numbers refer to similar items throughout the figures and:

FIG. 1 is a schematic block diagram of a computer system, in accordance with an example embodiment;

FIG. 2 is a schematic block diagram of a server, in accordance with an example embodiment;

FIG. 3 illustrates an example of a blackjack table representation at a first state, in accordance with an example embodiment;

FIG. 4 illustrates an example of a blackjack table representation at a second state, in accordance with an example embodiment;

FIG. 5 illustrates a flowchart of a method for a client device to facilitate a network-based, multiplayer game, in accordance with an example embodiment;

FIG. 6 illustrates an example of a game data structure, in accordance with an example embodiment;

FIG. 7 illustrates a flowchart of a method for a server to facilitate a network-based, multiplayer game, in accordance with an example embodiment;

FIG. 8 illustrates a flowchart of a method for a server to perform a multiple-user action stage, in accordance with an example embodiment;

FIG. 9 illustrates a flowchart of a method for a server to perform a single-user action stage, in accordance with an example embodiment; and

FIG. 10 illustrates a diagrammatic representation of machine in the example form of a computer system, within which a set of instructions, for causing the machine to perform any one or more of the methodologies discussed herein, may be executed.

### DETAILED DESCRIPTION

Embodiments include methods and apparatus for facilitating network-based, multiplayer games. Examples of applicable multiplayer games include, but are not limited to, blackjack, poker, keno, roulette, craps, racing games, sports betting games (e.g., boxing, horse racing, etc.), board games (e.g., checkers, chess, Monopoly, etc.), course navigation games, fighting games, and other types of network-based multiplayer games. Although the description, below, describes implementing embodiments in a network-based blackjack game, it is to be understood that the scope of the subject matter includes other types of multiplayer games, as well.

In an embodiment, a network-based, multiplayer game may be, for example, a blackjack game. A blackjack game may be implemented as a server application, which is capable of communicating with various types of clients, in an embodiment. In an embodiment, the server application maintains a virtual “table” for all iterations associated with a particular game. Similar to an actual blackjack game played at a casino, for example, one or more players (also referred to as “users”), through interaction with their respective client devices, may join the table (e.g., join the game). Accordingly, a first player may join a table using his home computer located in Israel, while a second player may join the same table using her cellular telephone in Brazil, in an embodiment.

Joining a “table” is analogous to joining a “game,” in various embodiments. For example, a “table” may represent a casino-style gambling table used to play a blackjack, poker, roulette, craps, or other types of table-based games. In other embodiments, a “game” may be represented using another type of representation. For example, a “game” may be played on a virtual gameboard, adventure course, arena, or other manifestation. It is intended that the scope of the inventive subject matter be extended to such other manifestations, and use of the term “table” is not meant to limit the scope of the inventive subject matter to table-based games. The term “table,” as used herein, may be interchangeably construed to mean “game.”

During play, multiple “iterations” of the game may be performed. For example, a single game iteration for a particular blackjack game may include each player placing a bet, providing player inputs to “hit” or “stand,” and receiving feedback on whether the deal has resulted in a win, lose or draw for the player. As long as a player has sufficient credit, the player may participate in as many game iterations as he or she would like.

In a multiplayer scenario, more than one person may be playing on and/or viewing the blackjack table at any particular time. The “actions” performed by each player may affect the state of the game (e.g., the state of the table), and thus may affect the decisions of the other players. Accordingly, it is desirable that each player be notified when the table's state is changed. Assume, for example, that three players, X, Y, and Z, are participating in a blackjack game at a particular table.

There are at least four kinds of table state changes that a player, X, may expect:
1. A change caused by an action that player X had done by himself (e.g., press the “HIT” button when it was his turn to play).
2. A change caused by one other player (e.g., player X is watching a “HIT” action done by player Y when it is Y's turn to play).
3. A change caused by an action that was done by more than one player at the table (e.g., a “place your bets” round when all the players may be placing their bets, both player X and Y want to see the bets each other are placing), and
4. A change caused by an action by the system, which may be represented as the dealer (e.g., the dealer notices that player Y is not responding in her turn and tells the other players they should skip player Y's turn).

Actions of the types 1 and 2, above, are referred to herein as “single-user action stages,” because the system expects an action request from just one of potentially multiple players. Actions of type 3, above, are referred to herein as “multiple-user action stages,” because the system expects action requests from multiple ones of the players (e.g., up to all of the players at the table).

In a typical client-server methodology, the server sends a response to a client only after receiving a request from the client. A typical server may not, itself, initiate a conversation with a client. Therefore, in order for player X to be notified regarding a change in the table, X should send a request for which the server will reply with the new state of the table.

For actions of type 1, above, the server may simply reply to player X's action request with a response that indicates the new state of the table. For actions of types 2 and 3, however, player X may not have sent an action request to the server. Regardless, player X should be notified when an action request from player Y or Z have affected the state of the table.

One solution may be to implement client-server “polling.” Using this technique, when it is player Y's turn to make an action request, users X and Z periodically (e.g., once per second) send dummy requests to the server. If there is no change in the table's state, the server responds with a negative answer. After player Y has made an action request, and the table's state has changed, the next time player X or Z sends a dummy request, the server may respond with a message indicating the table's new state. Such a solution may be inefficient, because the server may send numerous negative answers to players X and Z in response to their dummy requests. In addition, the clients associated with players X and Z expend significant resources periodically performing the tasks of generating and sending dummy requests, and receiving, parsing, and evaluating negative answers.

Another solution may be to use “sockets.” A sockets implementation enables a client to initiate a connection with a server. Once a connection has been established, the server may send data to the client without requiring a client's explicit request. However, a sockets solution may limit the range of platforms that the system may support, because not all electronic devices support sockets. For example, a cellular telephone or television system may not have sockets capabilities. Further, sockets are typically implemented using different communications ports than the standard ports through which communications may be allowed by various communication firewalls. Because many firewalls block non-standard ports from being used, a sockets implementation may not be practical over a network that includes a firewall.

According to various embodiments of the inventive subject matter, clients may send “action requests,” and “watch requests” to a server, and the server may hold those requests in a virtual waiting area until satisfaction of a condition for releasing the requests. When requests are released, the server may perform any of a number of functions, including but not limited to updating the table's state, and responding to the requests with state update messages. In an embodiment, action requests, watch requests, and/or state update messages may include messages formatted using a markup language, such as HTML (Hyper-Text Markup Language), SGML (Standard Generalized Markup Language), XML (Extensible Markup Language), or another format. In an embodiment, a client device may send requests and receive state update messages using a standard port and communications protocol (e.g., port 80 supporting Hyper-Text Transfer Protocol (HTTP)).

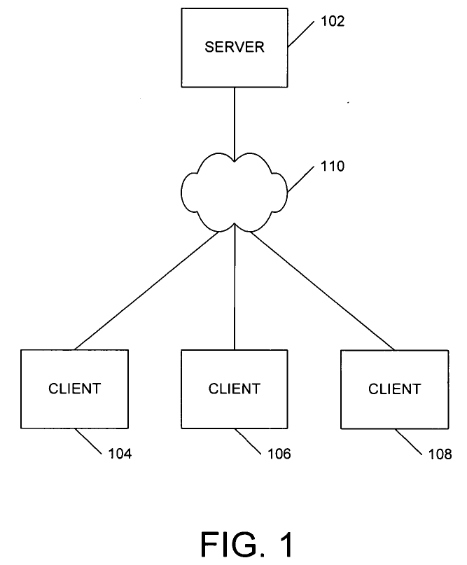

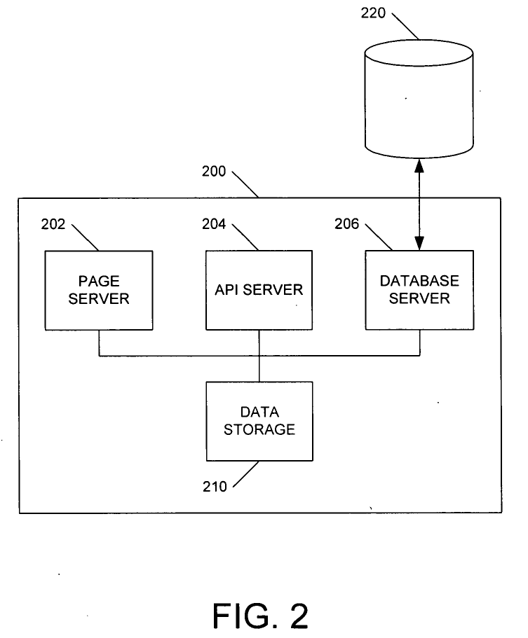

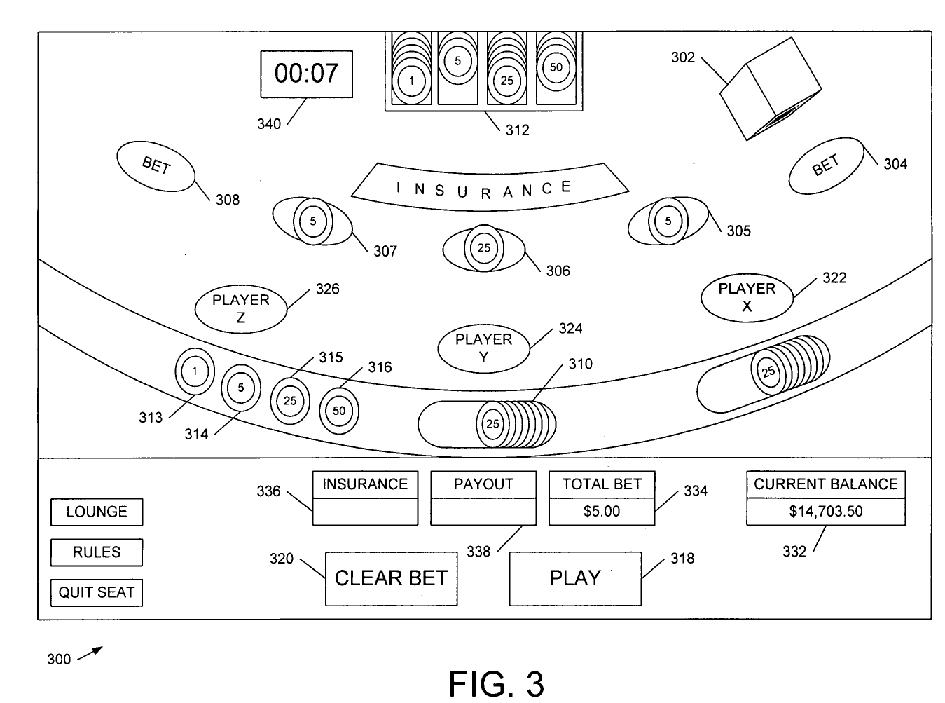

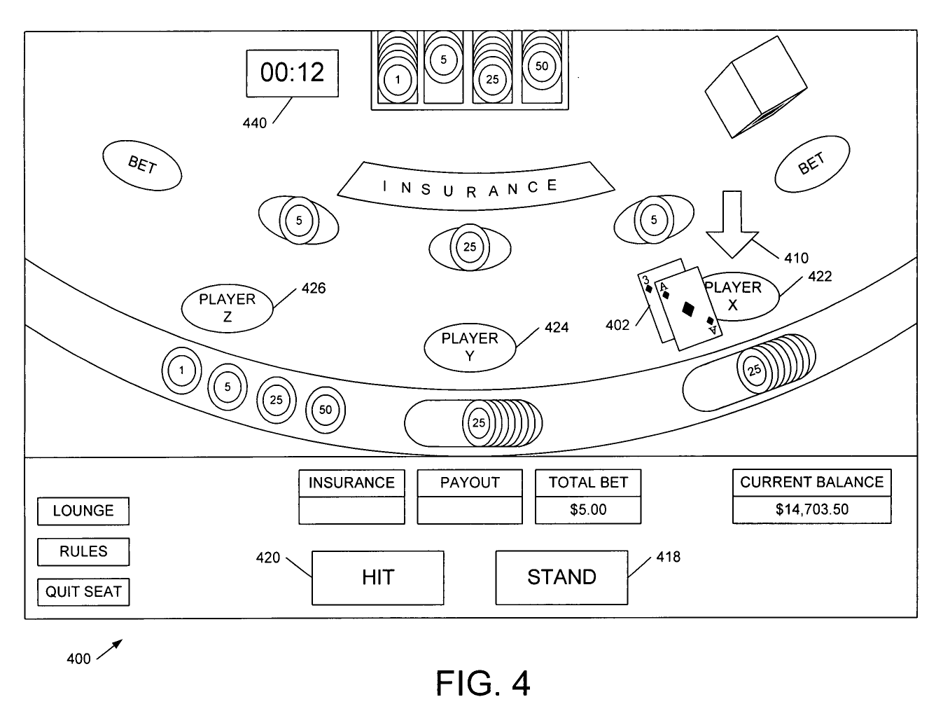

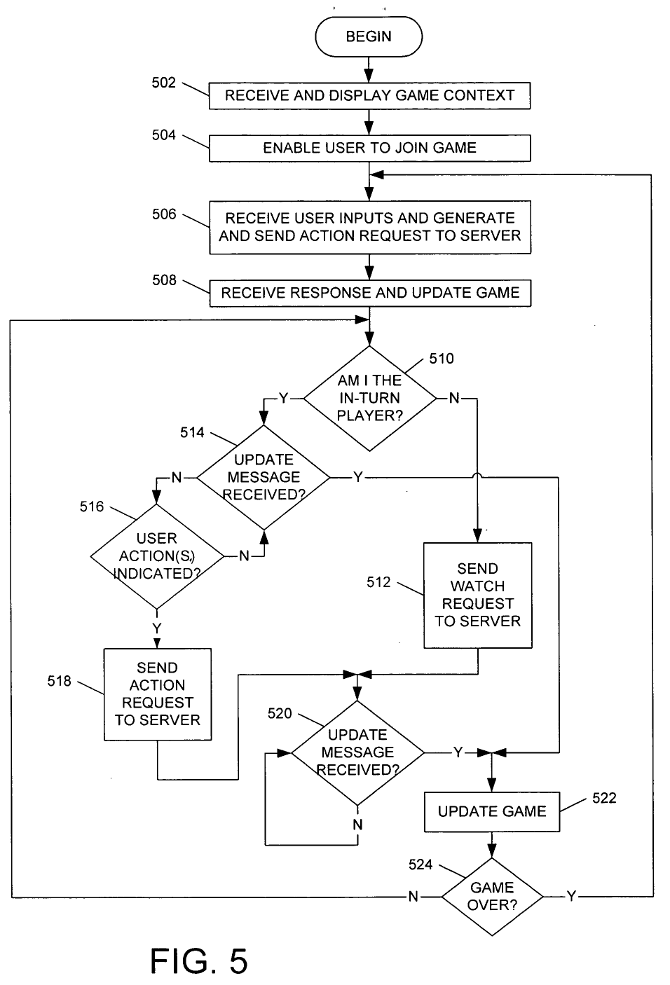

Example systems and servers, in which various embodiments may be implemented, are described below in conjunction with FIGS. 1 and 2. An example of two display screens for a blackjack game are described later in conjunction with FIGS. 3 and 4, in accordance with various embodiments. Example methods for implementing a network-based, multiplayer game are described later in conjunction with FIGS. 5-9.

FIG. 1 is a schematic block diagram of a computer system 100, in accordance with an example embodiment. In system 100, a server 102 may communicate with one or more clients 104, 106, 108 over one or more networks 110. Although one server 102, three clients 104, 106, 108, and one network 110 are illustrated in FIG. 1, different numbers of servers 102, clients 104, 106, 108, and networks 110 may be associated with system 100, and the numbers may change dynamically (e.g., as players join or leave games).

In an embodiment, network 110 includes the Internet. In other embodiments, network 110 may include a local area network (LAN), a wide area network (WAN), a wireless LAN (WLAN), a radio area network (RAN), a personal area network (PAN) (e.g., a Bluetooth network), a cellular network, a satellite network, a public switched telephone network (PSTN), or any combination thereof. Although the description, below, describes implementing embodiments in a system that includes the Internet, it is to be understood that the scope of the subject matter includes systems that employ other types of networks to provide communications between a server and client, as well.

In an embodiment, one or more network-based multiplayer games are executed and maintained on a server 102, and accessed by client programs (e.g., a browser) associated with clients 104, 106, 108. In an embodiment, a network-based multiplayer game may include a Java-based, enterprise application, or an application programmed using a different language. A multiplayer game, in accordance with an embodiment, may use open standards (e.g., XML, HTML, SGML, or others) and transport protocols (e.g., HTTP) to exchange information and data with calling clients.

As used herein, the term “server” is intended to include one or more first computing devices or computer programs executing on one or more computing devices, which provide one or more services to client programs or client devices. The term “client,” as used herein, is intended to include a second computing device or computer program executing on a computing device, which may request services from a server. Use of the terms “server” and “client” are not meant to limit the scope of the subject matter to any particular type of system. Instead, these terms are used for convenience to indicate various elements of a network-based communication system.

A client 104, 106, 108 may include one or more computing devices (e.g., processors) within a device such as a computer (e.g., a desktop personal computer (PC) or laptop computer), a personal digital assistant (PDA), a two-way pager, a cellular telephone, a television set and set-top box, an interactive television (ITV) system, a gaming system, a consumer electronics device, a web appliance, devices combining these functionalities, or virtually any other electronic device capable of providing two-way network communications, displaying information pertaining to a multiplayer game, and receiving user inputs associated with the game. In an embodiment, each client 104, 106, 108 may include a wired or wireless network interface, one or more processors, a display mechanism (e.g., a display or screen), and a user interface (e.g., keyboard, keypad, toggle switches, joystick, microphone, speaker, etc.).

Server 102 maintains and updates state information relating to a game. In addition, in an embodiment, server 102 receives messages from the one or more clients 104, 106, 108 via one or more networks 110, and may respond accordingly. As will be described in detail later, server 102 may hold certain user requests in a manner that enables the system to update all users as to the state of the game, regardless of whether or not it is the user's turn.

FIG. 2 is a schematic block diagram of a server 200, in accordance with an example embodiment. In an embodiment, server 200 includes one or more page servers 202, Application Programming Interface (API) servers 204, and database servers 206. Further, server 200 may include volatile and/or non-volatile data storage mechanisms 210, which may be accessible to servers 202, 204, 206.

Page servers 202 may deliver web pages (e.g., mark-up language documents) to clients. API servers 204 may provide a set of API functions for querying and writing to the server 200. Database servers 206 may facilitate communications with one or more remote databases 220. More, fewer, or different servers may be associated with server 200, in other embodiments.

An API executed on server 200 may implement a network-based, multiplayer game, in an embodiment. Such an API may be called using HTTP, for example, and information may be sent and received using a standard markup language message format (e.g., HTML, SGML, XML, or other). A client-side application used to interact with server 200 may be designed to communicate with a server-side API. In other embodiments, other protocols and/or messaging formats may be used to provide communications between a server and client.

The remaining Figures are used to illustrate the various communications between clients and servers, and the actions performed by clients and servers, according to various embodiments. The description will begin from the perspective of a client device, and then proceed to the perspective of a server. Again, a blackjack game will be described for the purposes of example only, although the scope of the inventive subject matter extends to various other network-based, multiplayer games, as well.

In an embodiment, a player (or “user”) may join a game table, such as a blackjack table, via a client device (e.g., device 102, 104, 106, FIG. 1). In a particular embodiment, a player invokes a browser on the client device, and accesses a website, which manages the game. For example, a player may access a website such as “www.playmontecarlo.com” (developed by BettingCorp UK Ltd., London, United Kingdom), may select to play “Multiplayer Blackjack,” and may join a particular table. In an embodiment, a visual representation of the table may be downloaded from the server to the client device and displayed.

FIG. 3 illustrates an example of a blackjack table representation 300 at a first state, which may be displayed on a client device, in accordance with an example embodiment. In an embodiment, table representation 300 includes various game elements, which may include a deck of cards 302, one or more betting areas 304, 305, 306, 307, 308, player chip reservoirs 310, a dealer chip reservoir 312, and chip indicators 313, 314, 315, 316.

Game elements may also include action initiation elements 318, 320, which may be different during various stages of the game. For example, during a betting round, action initiation elements 318, 320 may include a selectable “PLAY” element 318 and a selectable “CLEAR BET” element 320. Other action initiation elements may appear during play as elements integrated with the page or in popup windows. For example, but not by way of limitation, other selectable elements may include “SPLIT,” “PUSH,” “BUY INSURANCE,” and “DOUBLE DOWN,” among others.

In an embodiment, table representation 300 also includes one or more player indicators 322, 324, 326, which indicate and identify players currently associated with the table. For example purposes, these players are identified as “Player X” 322, “Player Y” 324, and “Player Z” 326. Further, table representation 300 may include various game state indicators, which may include a player balance indicator 332, a current bet indicator 334, an insurance indicator 336, a payout indicator 338, and a timer 340.

When a game state corresponds to a betting round, each player 322, 324, 326 may make a bet. For example, in an embodiment, Player X 322 may manipulate the user interface of his client device to drag one or more chip indicators 313-316 into the betting area 305 associated with Player X. The player's chip reservoir 310, current bet indicator 334, and balance indicator 332 may be adjusted at the client device, in response. Player Y 324 and Player Z 326 may perform similar actions before, concurrently with, or after Player X 322. Accordingly, a betting round may be considered a “multiple-user action stage.”

In an embodiment, timer 340 indicates a time remaining before expiration of the betting round. Timer 340 may be initialized to a certain number of seconds (e.g., from 10-30 seconds or more), and may count down to zero. If a player places one or more chips into his betting area (e.g., area 305) and selects the “PLAY” element 318, his associated client device generates and sends an action request (e.g., an XML message sent using HTTP) to the server, which indicates his bet. If the timer 340 expires prior to a player selecting the “PLAY” element 318, then his client device generates and sends an action request to the server, which indicates the total chip value that the player had placed in his betting area prior to expiration of timer 340. If no chips exist in a player's betting area upon expiration of the timer 340, then his client device may not generate and send an action request to the server, and the server may assume that the player is sitting out the round.

As will be explained in more detail later, the server holds the action requests for a multiple-user action stage of the game until action requests are received for some or all players, or until a timeout period has elapsed (e.g., as indicated by timer 340), in an embodiment. The server then releases the action requests (e.g., executes threads associated with the requests), updates the state of the table, and sends table state update messages (e.g., XML messages sent using HTTP) to the client devices associated with the players, in an embodiment. In an embodiment, updating the state of the table includes indicating the bets of all of the players who made bets, and simulating card dealing. A card dealing simulation may include execution of a random or semi-random card selection process for a player and for the dealer.

In an embodiment, the table state update messages indicate the bets made by all of the players and the card values dealt to the players. Upon receipt of a table state update message, a client device may display the bets of each player on each client device, and simulate dealing of the cards.

FIG. 4 illustrates an example of a blackjack table representation 400 at a second state, which may be displayed on a client device, in accordance with an example embodiment. The illustrated representation 400 includes dealt card elements 402, which indicate the cards dealt to Player X 422. In addition, in an embodiment, representation 400 includes a turn indicator 410, shown in FIG. 4 as an arrow, which indicates the player whose turn it is, referred to herein as the “in-turn player.” The other players, whose turn it is not, are referred to herein as the “out-of-turn players.”

In the example of FIG. 4, turn indicator 410 indicates that Player X 422 is the in-turn player. In an embodiment, only the in-turn player (e.g., Player X 422) may perform an action that affects the state of the game, and the out-of-turn players (e.g., Player Y 424 and Player Z 426) may simply observe. Accordingly, a playing stage may be considered a “single-user action stage.” In an embodiment, the out-of-turn players (e.g., Player Y 424 and Player Z 426) recognize that it is not their turn, and each one may send a “watch” request (e.g., an XML message sent using HTTP) to the server. As will be explained in more detail later, the server holds the watch requests from the out-of-turn players until after the server receives an action request from the in-turn player, or until a timeout period expires.

During a player's turn, action initiation elements 418, 420 may include a selectable “STAND” element 418 and a selectable “HIT” element 420. During his turn, a player may increase his bet, as described above, and/or may select the “STAND” element 418 or the “HIT” element 420.

In an embodiment, timer 440 indicates a time remaining before expiration of the player's turn. Timer 440 may be initialized to a certain number of seconds (e.g., from 10-30 seconds or more), and may count down to zero. If the in-turn player selects the “STAND” element 418 or the “HIT” element 420, his associated client device generates and sends an action request (e.g., an XML message sent using HTTP) to the server, which indicates his decision. During a turn, a player also may increase his bet, in an embodiment. If the timer 440 expires prior to a player selecting the “STAND” element 418 or the “HIT” element 420, then his client device may not generate and send an action request to the server, and the server may assume a default decision of “STAND.” As will be explained in more detail later, upon receipt of the in-turn player's action request (or upon expiration of a timeout period), the server updates the state of the table.

In an embodiment, if the in-turn player selects “HIT” element 420, updating the state of the table includes indicating the additional bets (if made) of the in-turn player, and simulating card dealing. The identity of the in-turn player may remain as Player X, 422, because Player X may still have the opportunity to “HIT” again (assuming his card total has not exceeded 21). Although not illustrated in FIG. 4, an in-turn player may be given additional options during a turn, as well. For example, but not by way of limitation, an in-turn player may be given options to “DOUBLE DOWN,” “SPLIT,” “PUSH,” or “BUY INSURANCE,” at various times.

In an embodiment, if the in-turn player selects “STAND” element 418, updating the state of the table includes indicating the additional bets (if made) of the in-turn player, and modifying the identity of the in-turn player (if any players have not yet taken their turn).

After updating the state of the table, in an embodiment, the server releases the watch requests received from and held for the out-of-turn players (e.g., executes threads associated with the requests), in an embodiment. The server then sends table state update messages to the client devices associated with each of the in-turn and out-of-turn players, in an embodiment. In an embodiment, the table state update messages indicates the additional bets made by the in-turn player (if any), and the card values dealt to the in-turn player (if any). Upon receipt of a table state update message, a client device may display the in-turn player's additional bets and simulate dealing of the cards to the in-turn player, if those actions were requested. Further, the table state update message may indicate the identity of the in-turn player, which may or may not have changed. Based on the information, turn indicator 410 may continue to indicate that Player X 422 is the in-turn player, or may move to another player (e.g., Player Y 424 or Player Z 426).

After the last player has taken his turn, updating the table state may also include determining which players have beaten the dealer, determining payouts (if any), and adjusting player balances. Accordingly, a table state update message may be sent to each player to indicate the results of these changes. A new iteration of the game may then begin. In an embodiment, this includes returning the state of the game to a betting round.

The example sequence of events given above is not intended to indicate all possible actions that a player/client or the dealer/server may perform. For example, any player may exit a game or fail to respond during a betting round or during his turn. As discussed previously, in an embodiment, the server may implement one or more maintenance or timing threads, which cause a player to be bypassed if he does not respond within a certain period of time. In addition, players may perform other actions that are not described in the context of the above example, such as playing an extra hand, if available, among other things. Modifications to client/server actions associated with other various game play actions, which may not be described in the example given above, are intended to fall within the scope of the inventive subject matter.

The remaining Figures include flowcharts indicating embodiments of methods performed by clients and servers to facilitate network-based multiplayer games. Although the flowcharts are shown as procedures performed in a sequential manner, the various method embodiments could be performed using object-oriented or object-based techniques. Further, the sequence of procedures may be varied, in certain instances, while still achieving substantially similar results.

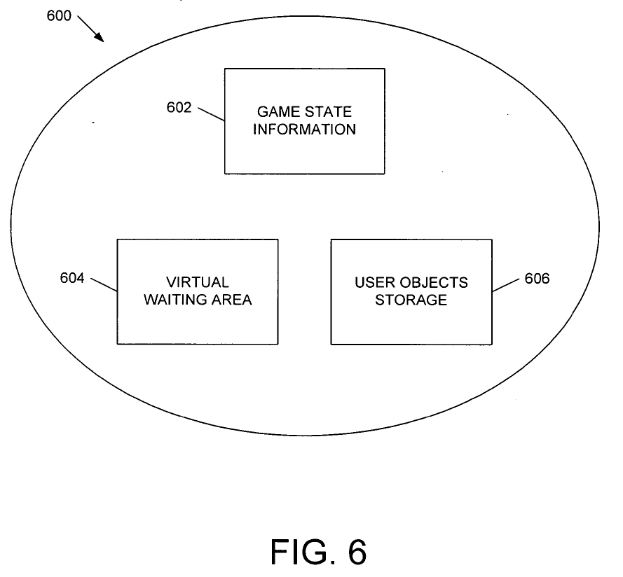

FIG. 5 illustrates an example embodiment of a sequence of game procedures from the perspective of a client device. FIGS. 6-9 illustrate embodiments of sequences of game procedures from the perspective of a server device.

FIG. 5 illustrates a flowchart of a method for a client device to facilitate a network-based, multiplayer game, in accordance with an example embodiment. The method begins, in an embodiment, when a client device receives and displays one or more pages and other information from a server, which may represent a physical embodiment of the context of a network-based, multiplayer game (e.g., a casino table, a visualization of a portion of a course, an arena, etc.). For example, a blackjack table (e.g., table 300, FIG. 3) may be received and displayed. The game context page may be displayed, for example, on a monitor associated with a client computer, a television screen, or a display area of a cellular telephone, two-way pager, or other portable electronic device.

A client device may receive a game context page, for example, by accessing a website (or other sharable network application) that supports one or more versions of the game. In an embodiment, a user may further select a particular game to play (e.g., select a particular blackjack table from a lounge). For example, using the blackjack example, a user may access a casino-style gambling website, indicate that the user would like to play “multiplayer blackjack,” and select a table (if multiple tables are provided). A user also may be given the opportunity to establish credit with the system, for example, if the system provides for actual betting.

In block 504, the client device enables a player (a user) to join a particular game (e.g., a table). For example, in a blackjack application, after a user has selected a particular game table, and the table representation has been displayed, the client device may display a selectable screen element such as “JOIN GAME?” When the user indicates that he would like to join the game, the client device may send one or more messages to the server to provide information so that the server may join the player in the game.

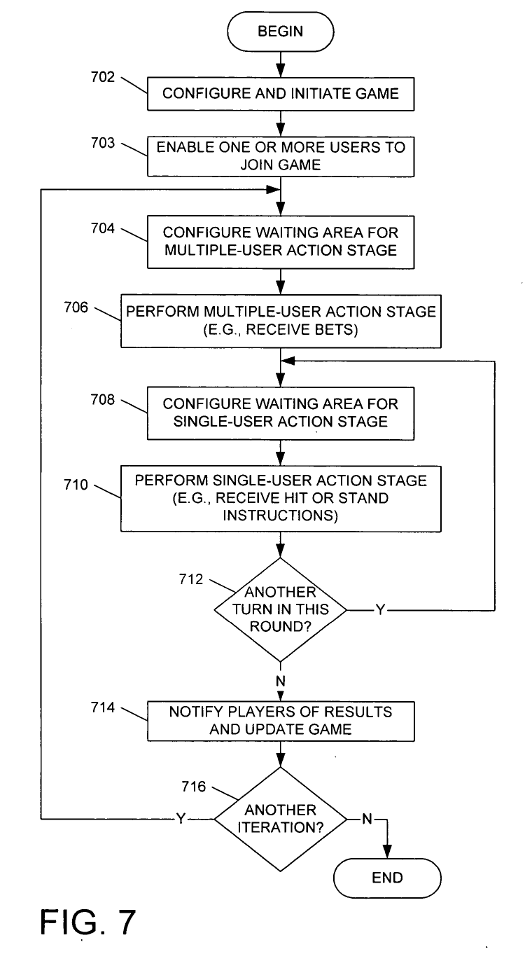

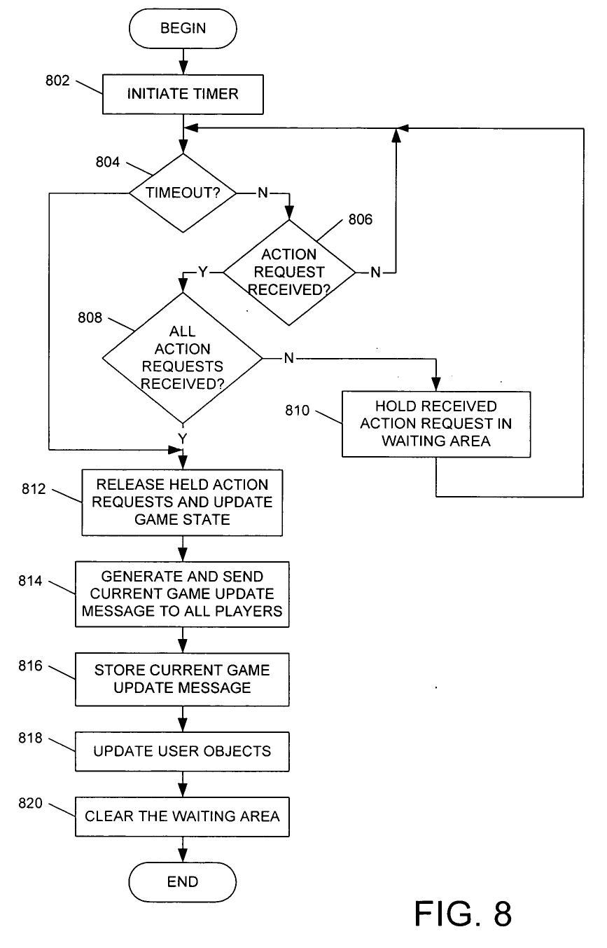

In an embodiment, a game may initially be in a multiple-user action stage, such as a stage in which one or more players may place bets. Accordingly, in block 506, the client device may receive user inputs (e.g., bet indications and a “PLAY” selection), generate an action request that includes the input information, and send the action request to the server. Server actions, which may be performed in response to receiving such a request, are described later in conjunction with FIGS. 7 and 8. If a player does not place a bet within a certain period of time, then that player is bypassed, in an embodiment. Although this may occur, it is not represented in FIG. 5 for ease of illustration and description.

After sending an action request, a server response may be received, in block 508, in the form of one or more game update messages. In an embodiment, the client device updates the visual representation of the game, accordingly. For example, a client device may update the visual representation of the table to show all of the player bets that have been made.

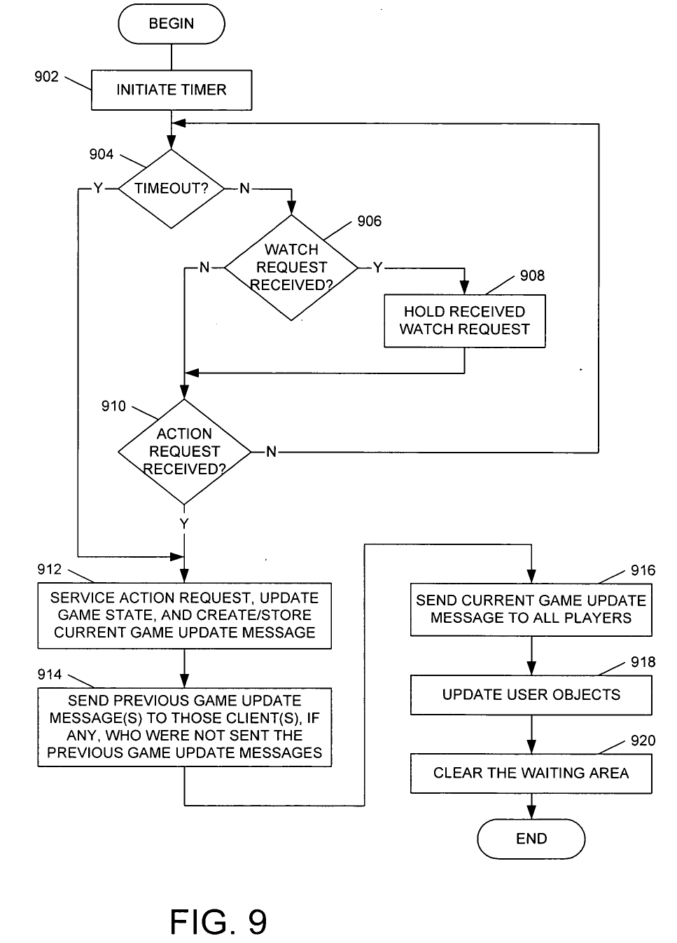

A game may then proceed to a single-user action stage, in an embodiment. If such is the case, a determination may be made, in block 510, whether the client device is associated with the in-turn player. If not, then the player may observe but not play, during that game stage, and the client device may send a “watch request” to the server, in block 512, in an embodiment. In a particular embodiment, a client device for an out-of-turn player may send only one watch request to the server during a single-user action stage, and wait for the server to respond (as opposed to periodically polling the server). Server handling of a watch request in conjunction with a single-user action stage is described in detail later in conjunction with FIGS. 7 and 9.

If the client device does represent the in-turn player (as determined in block 510), then the user may play during that game stage. In an embodiment, if a player waits too long to take his or her turn, then the server may assume a particular player action (e.g., “STAND,”), and may update the game accordingly. In an embodiment, a determination is made, in block 514, whether a game update message has been received from the server. If not, then a further determination is made, in block 516, whether a user action has been indicated (e.g., “STAND,” “HIT,” “SPLIT,” and/or a bet modification). If so, then the client device sends an “action request” to the server, in block 518, in an embodiment. Server handling of an action request in conjunction with a single-user action stage is described in detail later in conjunction with FIGS. 7 and 9.

Once the client device sends a wait request (in block 512) or an action request (in block 518), the client device waits for and/or determines whether a game update message has been received from the server, in block 520. When a determination is made that a game update message has been received (in blocks 520 or 514), then the client device updates the game (e.g., the table) according to the information in the game update message, in block 522. For example, the client device may update the displayed game representation to indicate modified bets and/or a simulated card deal, among other things. If the last player has taken his turn, then the game update message may also indicate whether or not the player has won, lost or drawn, as well as the monetary winnings or losses.

A determination may then be made, in block 524, whether the game iteration is over (e.g., whether all participating players have taken their turns). If not, then the procedure iterates as shown, and a determination is again made whether it is the player's turn, in block 510. If the game iteration is over, as determined in block 524, then the procedure iterates as shown, where a new betting round or other multiple-user action stage may be initiated.

FIG. 5 is not meant to illustrate all possible state changes or actions that may occur during a typical game iteration. For example, a user may leave a game at any time, or may fail to respond when it is the user's turn. In such cases, the server may assume that the user has passed, and may update the game state accordingly. Further, other types of games may include more than one multiple-user action stage, and or the sequencing between the single-user and multiple-user action stages may be performed in different orders. Variations in the illustrated client-side flow of procedures of FIG. 5 may be used for different types of games and/or for game iterations in which different actions are performed by a player.

Embodiments of network-based, multiplayer games will now be described from a server perspective, in conjunction with FIGS. 6-9. As will be described in more detail later, a game may be established or configured on a server prior to or in response to a first player's attempt to join the game. In an embodiment, configuring a game may include, for example, configuring a data structure in which game-related information may be stored and updated. In an embodiment, the data structure for a particular game is referred to as a table.

FIG. 6 illustrates an example of a game data structure, in accordance with an example embodiment. Game data structure 600 may exist, for example, within one or more data storage mechanisms (e.g., data storage 210, FIG. 2) associated with a server. In an embodiment, game data structure 600 includes game state information 602, a virtual waiting area 604, and user objects storage 606.

Game state information 602 may include, for example, information indicating the current stage of the game (e.g., idle stage, betting stage, playing stage, etc.). In addition, in an embodiment, game state information 602 includes a state sequence indicator (e.g., an integer value), which may be updated (e.g., incremented) each time a player-initiated or system-initiated state change occurs. Further, during play, game state information 602 may include, for example, information indicating each player's current bet, each player's card values, the dealer's card values, and the identity of the in-turn player, among other things.

Virtual waiting area 604 includes a storage area for holding one or more watch requests, in an embodiment. In a particular embodiment, a watch request may be held in the virtual waiting area as a user thread, which may be held or suspended by the system and later activated in response to a triggering event.

User objects storage 606 may include a user object for each player who has joined the game. In an embodiment, each user object includes a user identifier (ID), which is a persistent value that is unique to each user, and a session ID (or login ID), which may be associated with the user throughout a particular session. Further, in an embodiment, each user object may include a record of the user's account (e.g., outstanding bets, an uncommitted user balance, etc.).

Still further, in an embodiment, a user object may include a “reported state sequence indicator”, which indicates the most recently-reported state information that the server sent to the user. For example, when the server sends a game update message to a particular user, the information contained within the message may be associated with the then-current state sequence indicator (e.g., sequence number “104”). The server may then update the reported state sequence indicator within the user object (e.g., to a value of “104”). As will be described later, the reported state sequence indicator, within a user object, may be used to determine whether a particular user has not been sent a previous game update message.

FIG. 7 illustrates a flowchart of a method for a server to facilitate a network-based, multiplayer game, in accordance with an example embodiment. The method begins, in an embodiment, when the server initiates and configures a game, in block 702. Initiating a game may include loading and starting an instance of the game application. Configuring a game may include, for example, establishing a data structure, such as that illustrated in FIG. 6, and populating the data structure with state information (e.g., game state information 602, FIG. 6) and user objects (assuming one or more users have joined the game) (e.g., within user objects storage 606). The state information may dynamically change during game play. In addition, user objects may be added to and removed from user objects storage during game play, as users join and leave a game, respectively. The contents of each user object also may be dynamically changed during game play.

The server may enable one or more users to join the game, in block 703. A user may join the game, for example, by accessing a website associated with the game, and indicating that the user wishes to join. When a user joins the game, a user object corresponding to the user is stored within the user object storage.

In an embodiment, the server initially configures the game's virtual waiting area (e.g., virtual waiting area 604) for a multiple-user action stage, in block 704. In an embodiment, this includes indicating, to the waiting area, release conditions that may trigger activation of any user messages or threads that may be stored within the waiting area during a multiple-user action stage of the game. For example, if a first game stage corresponds to a betting stage, then the virtual waiting area may be configured to hold received user action requests until such messages are received for some or all players, or until a timeout period has elapsed.

In block 706, a multiple-user action stage of the game may be performed. As will be described in more detail in conjunction with FIG. 8, a multiple-user action stage, such as a betting stage, includes the server starting a timer (e.g., a timer thread), and receiving and holding some or all action requests (e.g., bets and “PLAY” indications) until a release condition occurs. In an embodiment, the action requests are held in a virtual waiting area. In a further embodiment, a first release condition may be the server's determination that it has received action requests for some or all players that are joined in the game. A second release condition may be an expiration of the timer. If any players have not responded prior to expiration of the timer, then they are assumed to be sitting out for that game iteration, and messages from the non-responsive players are essentially ignored by the server. Once either release condition has occurred, the server releases (e.g., acts upon or executes) the action requests or threads within the waiting queue, changes the state of the game, and sends game update messages to all of the players joined in the game.

Referring again to FIG. 7, in block 708, the server configures the game's virtual waiting area (e.g., virtual waiting area 604) for a single-user action stage. In an embodiment, this includes indicating, to the waiting area, release conditions that may trigger activation of any user messages or threads that may be stored within the waiting area during a single-user action stage of the game. For example, if a next game stage corresponds to a player's turn, then the virtual waiting area may be configured to hold received watch messages until a user action request is received for the in-turn player or until a timeout period has elapsed.

In block 710, a single-user action stage of the game may be performed. As will be described in more detail in conjunction with FIG. 9, a single-user action stage, such as player's turn, includes the server starting a timer (e.g., a timer thread), and receiving and holding some or all watch messages from out-of-turn players until a release condition occurs. In an embodiment, the watch messages are held in a virtual waiting area. In a further embodiment, a first release condition may be the server's determination that it has received an action request (e.g., “HIT,” “STAND” or “SPLIT”) from the in-turn player. A second release condition may be an expiration of the timer. If the in-turn player has not responded prior to expiration of the timer, then an action may be assumed for the player (e.g., “STAND”). Once either release condition has occurred, the server changes the state of the game, releases (e.g., acts upon or executes) the watch messages or threads within the waiting queue, and sends game update messages to all of the players joined in the game.

Once an in-turn player has sent an action request or his turn has timed out, then a next turn may begin, if any are left in the game iteration. Referring again to FIG. 7, a determination is made, in block 712, whether another player turn remains in the game iteration. The next player turn may go to the same player as the previous turn (e.g., when a player previously sent a “HIT” action request and has not exceeded a card total of “21”), or the next player turn may go to another player (e.g., the player sitting to the left of the previous player). When another player turn remains in the game iteration, then the procedure iterates as shown, where the waiting area may be re-configured for a single-user action stage (or simply cleared), and another single-user action stage is performed.

When no further player turns remain in the game iteration, then in block 714, the server may notify players of results of the game iteration. For example, the server and/or clients may simulate the dealer exposing his cards, performing one or more “HIT” actions (e.g., if the dealer's card total is less than one or more player card totals), and may send messages to the clients to indicate which players have won, lost or drawn, as well as the players winnings or losses. In an embodiment, the server also updates some or all of the user objects to reflect the user's new balances, if they have changed. In a further embodiment, the server may interact with a database (e.g., database 220, FIG. 2) to update a persistent version of the user's balance, as well.

In block 716, a determination is made whether another iteration of the game should be played. In an embodiment, if any players remain at the table with a positive balance, then another iteration may be assumed. In an alternate embodiment, the server may seek user inputs to determine if each player would like to play again (e.g., “Another Round?” popup). When another iteration should be played, the game iterates as shown, where the waiting area may be re-configured for a multiple-user action stage, and another multiple-user action stage is performed. If no further iterations are to be played, then the game ends.

The flowchart of FIG. 7 includes a sequence of processes that may be applicable to an embodiment of a blackjack game. Other types of games may be performed in different sequences. For example, other types of games may perform only multiple-user action stages or single-user action stages, but not both. Alternatively, other types of games may perform multiple-user action stages and single-user action stages in different orders from the order illustrated in FIG. 7, and/or more or fewer of either type of stage may be performed during a game iteration. In other words, the flow of processes may be modified to suit a particular game.

FIGS. 8 and 9 illustrate more detailed descriptions of embodiments of a multiple-user action stage and a single-user action stage, respectively. In particular, FIG. 8 illustrates a flowchart of a method for a server to perform a multiple-user action stage (e.g., block 706, FIG. 7), in accordance with an example embodiment.

The method begins, in block 802, by the server initiating a timer associated with the multiple-user action stage. In an embodiment, the timer is implemented as a timing or maintenance thread, which is executed by the server. A purpose of the timer is to serve as a backup release condition, in case a primary release condition (e.g., the server receiving action requests from all participating players, indicating they have placed a bet and selected “PLAY”) has not occurred prior to expiration of the timer. In an embodiment, the timer is initiated to a first value (e.g., 15 seconds, or more or less), and the timer counts down until it reaches a value of zero.

In block 804, a determination may be made whether a timeout condition has occurred. In an embodiment, a timeout condition may occur when the timer has expired (e.g., in the case of a timer that counts down), or has reached a timeout value (e.g., in the case of a timer that counts up). In an embodiment, when such a condition occurs, a server interrupt may be produced, thus enabling the server to determine that a timeout condition has occurred.

If a timeout condition has not yet occurred, then a further determination may be made whether the server has received an action request, in block 806. For example, an action request received during a betting round may indicate a player's bet, and that the player has selected a “PLAY” element of the game. If no action request has been received, then the method may iterate as shown. In an embodiment, a server interrupt may be produced upon receipt of an action request, thus enabling the server to determine that an action request has been received.

If an action request has been received, as determined in block 806, a further determination may be made, in block 808, whether the server has received action requests from all players joined at the table. If not, then in block 810, the server places and holds the received action request in a virtual waiting area, in an embodiment. For example, this may be achieved by blocking a thread associated with servicing the received action request. The method may then iterate as shown.

In an embodiment, receipt of action requests from all participating players may be considered a primary “release condition,” which may trigger the server to release the action requests that have been received and held in the virtual waiting area. In an embodiment, this includes unblocking previously-blocked threads associated with those action requests. A secondary release condition may be the expiration of a timer (e.g., a timeout condition occurring).

Accordingly, when a determination is made, in block 804, that a timeout condition has occurred or when a determination is made, in block 808, that the server has received action requests from all players joined at the table, then any action requests being held in the virtual waiting area may be released, in block 812. In an embodiment, this includes unblocking the threads associated with the held action requests. In addition, the last-received action request, which may or may not have been placed in the virtual waiting area, also may be serviced. In an embodiment, request servicing (e.g., thread execution) may result in the state of the game being changed. For example, the game state may be changed to reflect each participating player's bet, and also to indicate the first player to be the in-turn player.

In block 814, the server may generate and send a “current” (as opposed to “previous,” as will be described later) game update message to the participating players, in an embodiment. In addition, a current game update message may be sent to players who are sitting out the round. A game update message may include, for example, each player's current bet, and an indication of the player who is the “in-turn” player for the next game stage. In an embodiment, the current game update message is stored, in block 816, for possible future transmission. Each game update message may be assigned a sequence number or other identifier, which may be stored with the game update message, in an embodiment.

In block 818, user objects (e.g., user objects stored in user objects storage 606, FIG. 5) for the participating players may be updated. In an embodiment, this may include decrementing a volatile version of the user's balance to reflect the user's bet. In addition, in an embodiment, this may include updating a reported state sequence indicator, within the user object, which indicates the most recently-reported game update message sent from the server to the client device associated with the user. As will be described later, the reported state sequence indicator, within a user object, may be used to determine whether a particular user has not been sent a previous game update message.

In block 820, the virtual waiting area may be cleared (e.g., overwritten with initialization values), and the method for a server to perform a multiple-user action stage may end. In an embodiment, after a multiple-user action stage of a game, one or more single-user action stages may be performed. In another embodiment, another multiple-user action stage may be performed or the game iteration may end.

FIG. 9 illustrates a flowchart of a method for a server to perform a single-user action stage (e.g., block 710, FIG. 7), in accordance with an example embodiment. The method begins, in block 902, by the server initiating a timer associated with the single-user action stage. In an embodiment, the timer is implemented as a timing or maintenance thread, which is executed by the server. A purpose of the timer is to serve as a backup release condition, in case a primary release condition (e.g., the server receiving an action requests from an in-turn player) has not occurred prior to expiration of the timer. In an embodiment, the timer is initiated to a first value (e.g., 15 seconds, or more or less), and the timer counts down until it reaches a value of zero.

In block 904, a determination may be made whether a timeout condition has occurred. In an embodiment, a timeout condition may occur when the timer has expired (e.g., in the case of a timer that counts down), or has reached a timeout value (e.g., in the case of a timer that counts up). In an embodiment, when such a condition occurs, a server interrupt may be produced, thus enabling the server to determine that a timeout condition has occurred.

If a timeout condition has not yet occurred, then a further determination may be made whether the server has received a watch request, in block 906. For example, a watch request received from a first client during another client's turn may indicate that the first client recognized that it is not its turn, and sent the watch request with the intention of waiting to be notified of the in-turn player's decision. In an embodiment, a server interrupt may be produced upon receipt of a watch request, thus enabling the server to determine that a watch request has been received.

If a watch request has been received, as determined in block 906, then in block 908, the server places and holds the received watch request in a virtual waiting area, in an embodiment. For example, this may be achieved by blocking a thread associated with servicing the received watch request. The method may then iterate as shown.

If no watch request has been received or after placing a watch request in the virtual waiting area, then a further determination is made, in block 910, whether the server has received an action request from the in-turn player. For example, the server may receive an indication that the in-turn player has selected “HIT” or “STAND.” In an embodiment, a server interrupt may be produced upon receipt of an action request, thus enabling the server to determine that an action request has been received. If an action request has not yet been received, then the method iterates as shown.

In an embodiment, receipt of an action request from the in-turn player may be considered a primary “release condition,” which may trigger the server to release the watch requests that have been received and held in the virtual waiting area. In an embodiment, this includes unblocking previously-blocked threads associated with those watch requests. A secondary release condition may be the expiration of a timer (e.g., a timeout condition occurring).

Accordingly, when a determination is made, in block 904, that a timeout condition has occurred or when a determination is made, in block 910, that the server has received an action request from the in-turn player, then the received action request is serviced, and the game state is updated accordingly, in block 912. In addition, the server may generate a “current” (as opposed to “previous,” as will be described in conjunction with block 914) game update message, in an embodiment. A game update message may include, for example, the in-turn player's current bet, new card values (e.g., if the in-turn player requested a “HIT”), and an indication of the player who is the “in-turn” player for the next game stage. In an embodiment, the current game update message is stored for possible future transmission, along with a sequence number or other identifier.

A possibility may exist that the server receives an action request from the in-turn player before the server receives watch requests from all out-of-turn players. If this situation occurs, then the server may not have a watch request to service for all participating players when the watch requests are released from the virtual waiting area. A “late-responding, out-of-turn player” is defined herein as an out-of-turn player for whom the server did not receive a watch request prior to receiving an action request from an in-turn player. In an embodiment, a reported state sequence indicator stored in each user object may be used by the server to identify a late-responding, out-of-turn player during a next single-user action stage or multiple-user action stage.

In an embodiment, a server may evaluate the reported state sequence indicator within some or all user objects to determine whether each user has received all previously-sent game update messages. For example, if the current game update message has a sequence number of “104,” and each user object indicates that the last game update message sent to each user had a sequence number of “103,” then an assumption may be made that each client has received all previously-sent game update messages. However, if a user object indicates that the last game update message set to a particular client has a sequence number of “102,” it may indicate that the client was a late-responding, out-of-turn player during a previous turn. Accordingly, that client may not have been sent a previous game update message. In an embodiment, when the server identifies such a situation, the server may, in block 914, send one or more previous game update messages to those clients, if any, that had not been sent the previous game update messages. This may enable the client to bring its game state up to date. In an embodiment, previous game update messages, if any, are sent to late-responding, out-of-turn players together with the current game update message (e.g., in the same message). In other words, blocks 914 and 916 may be performed together. However, for ease of description, blocks 914 and 916 are shown separately. In an alternate embodiment, previous game update messages, if any, are sent to late-responding, out-of-turn players before sending the current game update message. In another alternate embodiment, previous game update messages and current game update messages may be sent in different orders, and the client device may determine the sequence in which the client will apply updates.

In block 916, the server may send the current game update message (created in block 912) to the participating players, in an embodiment. In addition, a current game update message may be sent to players who are sitting out the round. When a client receives a current game update message, the client may update the displayed table to reflect the game's current state.

In block 918, user objects (e.g., user objects stored in user objects storage 606, FIG. 5) for the in-turn and out-of-turn players may be updated. In an embodiment, this may include decrementing a volatile version of the in-turn player's balance to reflect the player's additional bet, if any. In addition, in an embodiment, this may include updating a reported state sequence indicator, within the user object, for each user to whom a current game update message was sent. As indicated previously, the reported state sequence indicator indicates the most recently-reported game update message sent from the server (e.g., the current game update message) to the client device associated with the user.

In block 920, the virtual waiting area may be cleared (e.g., overwritten with initialization values), and the method for a server to perform a single-user action stage may end. In an embodiment, after a single-user action stage of a game, one or more additional single-user action stages may be performed. In another embodiment, a multiple-user action stage may be performed or the game iteration may end.

The various procedures described herein can be implemented in hardware, firmware or software. A software implementation could use microcode, assembly language code, or a higher-level language code to define a set of program instructions. The program instructions may be stored on one or more volatile or non-volatile computer readable media which, during execution, may perform various embodiments of the methods described herein. These computer readable media may reside at a server, a client device, or both, and may include hard disks, removable magnetic disks, removable optical disks, magnetic cassettes, flash memory cards, digital video disks, Bernoulli cartridges, random access memories (RAMs), read only memories (ROMs), and the like.

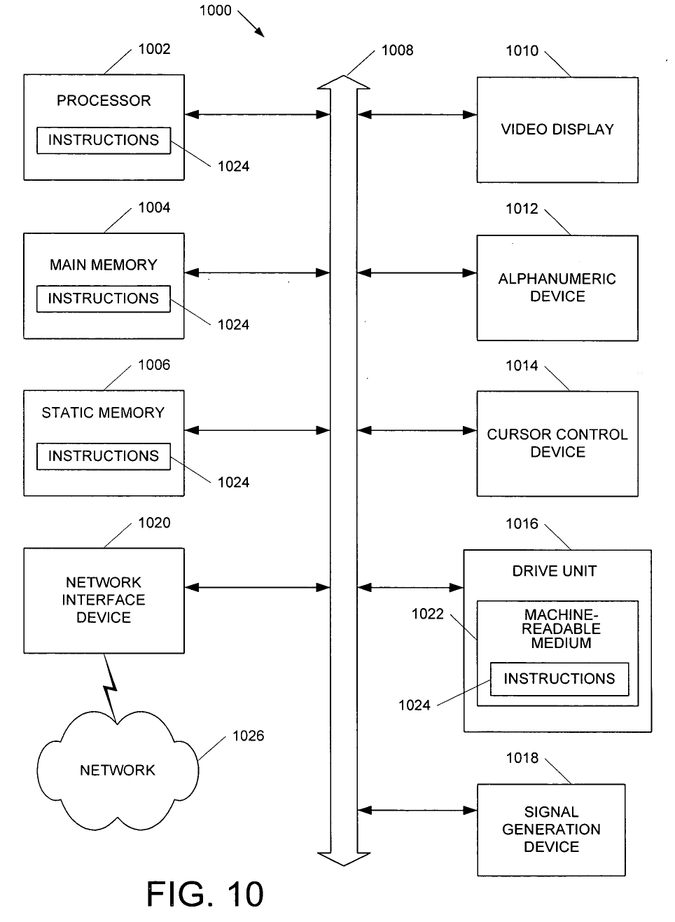

FIG. 10 shows a diagrammatic representation of machine in the example form of a computer system 1000, within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer, a laptop computer, a personal digital assistant (PDA), a two-way pager, a cellular telephone, a television set and set-top box, an interactive television (ITV) system, a gaming system, a consumer electronics device, a web appliance or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 1000 includes a processor 1002 (e.g., a central processing unit (CPU), a graphics processing unit (GPU) or both), a main memory 1004, and a static memory 1006, which communicate with each other via a bus 1008. The computer system 1000 may further include a video display unit 1010 (e.g., a liquid crystal display (LCD) or a cathode ray tube (CRT)). The computer system 1000 also may include an alphanumeric input device 1012 (e.g., a keyboard), a user interface (UI) navigation device 1014 (e.g., a mouse), a disk drive u nit 1016, a signal generation device 1018 (e.g., a speaker), and a network interface device 1020.

The disk drive unit 1016 includes a machine-readable medium 1022 on which is stored one or more sets of instructions and data structures (e.g., software 1024) embodying or utilized by any one or more of the methodologies or functions described herein. The software 1024 may also reside, completely or at least partially, within the main memory 1004 and/or within the processor 1002 during execution thereof by the computer system 1000, the main memory 1004 and the processor 1002 also constituting machine-readable media. The software 1024 may further be transmitted or received over a network 1026 via the network interface device 1020 utilizing any one of a number of well-known transfer protocols (e.g., HTTP).

While the machine-readable medium 1022 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals.

Thus, various embodiments of a method, apparatus, and system have been described which facilitate network-based, multiplayer games. Embodiments may be used in conjunction with numerous different systems, including but not limited to wired or wireless, computer networks, cellular communication systems, cable systems, satellite communication systems, interactive television systems, two-way paging systems, and casino-style gaming networks, among others. Further, embodiments may be used in conjunction with numerous different client platforms, including but not limited to wired or wireless computers (portable or stationary), cellular telephones, interactive television terminals, pagers, and gaming terminals, among others.

The foregoing description of specific embodiments reveals the general nature of the inventive subject matter sufficiently that others can, by applying current knowledge, readily modify and/or adapt it for various applications without departing from the generic concept. Therefore such adaptations and modifications are within the meaning and range of equivalents of the disclosed embodiments. The phraseology or terminology employed herein is for the purpose of description and not of limitation. Accordingly, the inventive subject matter embraces all such alternatives, modifications, equivalents and variations as fall within the spirit and broad scope of the appended claims.

1. A method performed by a server, the method comprising:
enabling one or more users to join a network-based, multiplayer game from one or more client devices;
receiving one or more requests from the one or more client devices;
holding the one or more requests in a virtual waiting area; and
releasing the one or more requests upon an occurrence of a release condition.

2. The method of claim 1, further comprising:
initiating the network-based, multiplayer game, wherein the network-based, multiplayer game includes a game selected from a group of games that includes blackjack, poker, keno, roulette, and craps.

3. The method of claim 1, wherein receiving the one or more requests comprises:
receiving one or more action requests during a multiple-user action stage of the game, wherein at least one of the one or more action requests indicates a bet.

4. The method of claim 3, wherein the release condition is a condition in which action requests have been received for all users joined in the game, and wherein releasing the one or more requests comprises:
determining whether the action requests have been received for all of the users joined in the game; and
when the action requests have been received for all of the users joined in the game, servicing the action requests by updating a game state, and sending messages to the one or more client devices indicating a current game state.

5. The method of claim 1, wherein receiving the one or more requests comprises:
receiving one or more watch requests during a single-user action stage of the game.

6. The method of claim 5, wherein the release condition is a condition in which an action request from an in-turn user has been received, and wherein releasing the one or more requests comprises:
determining whether the action request from the in-turn user has been received; and
when the action request has been received, servicing the watch requests by updating a game state, and sending messages to the one or more client devices indicating a current game state.

7. A method performed by a server, the method comprising:
enabling one or more users to join a network-based, multiplayer game from one or more client devices;
performing a multiple-user action stage of the game, which includes receiving and holding one or more action requests from at least some of the one or more users, and servicing the one or more action requests upon an occurrence of a first release condition; and
performing a single-user action stage of the game, which includes receiving and holding one or more watch requests from one or more out-of-turn users, and servicing the one or more watch requests upon receipt of an action request from an in-turn user.

8. The method of claim 7, further comprising:
initiating the network-based, multiplayer game, wherein the network-based, multiplayer game includes a game selected from a group of games that includes blackjack, poker, keno, roulette, and craps.

9. The method of claim 7, wherein performing the single-user action stage of the game comprises:
receiving the one or more action requests using a Hyper-Text Transfer Protocol;
holding the one or more action requests in a virtual waiting area;
determining whether action requests have been received for all of the users joined in the game; and
when the action requests have been received for all of the users joined in the game, servicing the action requests by updating a game state, and sending messages to the one or more client devices indicating a current game state.

10. The method of claim 7, wherein performing the multiple-user action stage of the game comprises:
receiving the one or more watch requests using a Hyper-Text Transfer Protocol;
holding the one or more watch requests in a virtual waiting area;
determining whether the action request from the in-turn user has been received; and
when the action request from the in-turn user has been received, servicing the watch requests by updating a game state, and sending messages to the one or more client devices indicating a current game state.

11. A method performed by a client device, the method comprising:
displaying a game context for a network-based, multiplayer game, wherein the game context is received over a network from a server;
enabling a user of the client device to join the network-based, multiplayer game; and
when the user is not an in-turn player during a single-user action stage of the game, sending a watch request to the server.

12. The method of claim 11, wherein displaying the game context comprises:
displaying a visual representation of a physical embodiment of a game selected from a group of games that includes blackjack, poker, keno, roulette, and craps.

13. The method of claim 11, wherein sending the watch request to the server comprises:
sending the watch request using a Hyper-Text Transfer Protocol.

14. The method of claim 11, wherein sending the watch request to the server comprises:
sending only one watch request to the server during the single-user action stage; and
waiting for a game state update message from the server in response to the only one watch request.

15. A method comprising:
a server enabling one or more users to join a network-based, multiplayer game from one or more client devices;
a client device displaying a game context for the game, wherein the game context is received from the server;
the client device enabling a user of the client device to join the network-based, multiplayer game;
the server receiving one or more requests from the one or more client devices;
the server holding the one or more requests in a virtual waiting area; and
the server releasing the one or more requests upon an occurrence of a release condition.

16. The method of claim 15, further comprising:
the server initiating the network-based, multiplayer game, wherein the network-based, multiplayer game includes a game selected from a group of games that includes blackjack, poker, keno, roulette, and craps.

17. The method of claim 15, wherein receiving the one or more requests comprises:
receiving one or more action requests during a multiple-user action stage of the game, wherein at least one of the one or more action requests indicates a bet.

18. The method of claim 15, wherein receiving the one or more requests comprises:
receiving one or more watch requests during a single-user action stage of the game.

19. An apparatus comprising:
a server to enable one or more users to join a network-based, multiplayer game from one or more client devices, to receive one or more requests from the one or more client devices, to holding the one or more requests in a virtual waiting area, and to release the one or more requests upon an occurrence of a release condition; and
one or more data storage mechanisms to store game state information, information in the virtual waiting area, and user objects.

20. The apparatus of claim 19, wherein the server is further to receive one or more action requests during a multiple-user action stage of the game, wherein at least one of the one or more action requests indicates a bet.

21. The apparatus of claim 19, wherein the server is further to receive one or more watch requests during a single-user action stage of the game.

22. An apparatus comprising:
one or more processors to receive a game context for a network-based, multiplayer game over a network from a server, to enable a user of the apparatus to join a network-based, multiplayer game, and when the user is not an in-turn player during a single-user action stage of the game, to send a watch request to the server; and
a display mechanism to display the game context.

23. The apparatus of claim 22, wherein the apparatus includes a device selected from a group of devices that includes a personal data assistant, a two-way pager, a cellular telephone, a television set and set-top box, and an interactive television system.

24. The apparatus of claim 22, wherein the apparatus includes a computer.

25. A computer readable medium having program instructions stored thereon, which when executed within a server, perform the method of claim 1.

26. A computer readable medium having program instructions stored thereon to, which when executed within a client device, perform the method of claim 11.

27. A server comprising:
means for enabling one or more users to join a network-based, multiplayer game from one or more client devices;
means for receiving one or more requests from the one or more client devices;
means for holding the one or more requests in a virtual waiting area; and
means for releasing the one or more requests upon an occurrence of a release condition.
